(19) United States
(12) Patent Application Publication
(10) Pub. No.: US 2013/0038755 A1
(43) Pub. Date: Feb. 14, 2013

(54) ELECTRONIC APPARATUS, METHOD OF TIME SYNCHRONIZATION, AND PROGRAM THEREFOR

(71) Applicant: Takamasa SATO, Kanagawa (JP)

(72) Inventor: Takamasa SATO, Kanagawa (JP)

(73) Assignee: SONY CORPORATION, Tokyo (JP)

(21) Appl. No.: 13/561,607

(22) Filed: Jul. 30, 2012

(30) Foreign Application Priority Data
Aug. 11, 2011 (JP) 2011-176235

(51) Int. Cl. H04N 5/76

(52) U.S. Cl. 348/231.5; 348/E05.024

(57) ABSTRACT

There is provided an electronic apparatus including an image pickup unit; a clock unit for measuring time; an image analysis unit for analyzing time indicated by a code display on an image captured by the image pickup unit and generating analysis time information; and a time correction unit for calculating the amount of correction to the time based on the image pickup time of the image used for the analysis and the time indicated by the analysis time information, and correcting the time of the clock unit based on the amount of correction to the time.

### BACKGROUND

The present technology relates to an electronic apparatus, a method of time synchronization and a program thereof. More particularly, the present technology relates to easily performing time synchronization among a plurality of electronic apparatuses.

There are times when one uses a plurality of electronic apparatuses having a image pickup function, for example, several digital cameras and video cameras, and performs editing tasks, such as, arranging still images captured by the respective digital cameras in time order or compiling videos from the respective video cameras into one video, and so on. When doing such tasks, the tasks could be easily carried out by using time information recorded on the still images or videos. However, if the electronic apparatuses are not in time synchronization, the editing tasks based on the time information will be unable to produce a result in the right time order. For this reason, for example, one would have to arrange the still images in time order by checking the content of the images or set edit points of the videos, which renders the editing tasks difficult. Therefore, there is a need to match the time of each electronic apparatus when performing an editing task by using time information. For instance, JP 2010-197320 A discloses synchronizing the time of a slave device with a master device by performing communications between the slave device and the master device which are connected with each other via a transmission line. In addition, using a radio signal with time information superimposed thereon as a method of automatic time correction has been put into practical use.

### SUMMARY

Meanwhile, in the case of connecting electronic apparatuses through transmission lines and performing communications, it is necessary to provide a communication circuit corresponding to a protocol for time synchronization, in order to perform proper communications of time information. In addition, when using radio signals with time information superimposed thereon, for example, radio signals transmitted from a navigation satellite, radio signals transmitted from a base station or a communication terminal in the radio communication network, radio signals indicating time information that is transmitted from an NTP (Network Time Protocol) protocol via a communication terminal, etc., it is necessary to provide a receiver circuit for receiving radio signals. Moreover, settings for network access are also required.

In addition, if the time adjustment of each electronic apparatus is performed manually, not only is it required to follow a complicated procedure, but it is also difficult to make the exact time adjustment.

Therefore, in the present disclosure, there are provided an electronic apparatus, a method of time synchronization and a program thereof, which enable easy time synchronization between an electronic apparatus having an image pickup function and an electronic apparatus having a displaying function.

According to a first embodiment of the present technology, there is provided an electronic apparatus comprising an image pickup unit; a clock unit for measuring time; an image analysis unit for analyzing time indicated by a code display on an image picked up by the image pickup unit and generating analysis time information; and a time correction unit for calculating the amount of correction to the time based on the image pickup time of the image used for the analysis and the time indicated by the analysis time information, and correcting the time of the clock unit based on the amount of correction to the time.

In the electronic apparatus according to the present technology, the difference between the image pickup time and the time indicated by the analysis time information is regarded as the amount of correction to the time, and based on this amount of correction the time of the clock unit is corrected. In addition, if the image contains a plurality of code displays and thus a plurality of times are acquired from the analysis of the code displays, for example, based on information indicating update intervals displayed corresponding to the code displays, or based the order in which the code displays are arranged, the difference between the time with a shorter update interval and the image pickup time is regarded as the amount of correction to the time.

According to a second embodiment of the present technology, there is provided a time synchronization method comprising measuring time by a clock unit; analyzing the time indicated by a code display on an image picked up by an image pickup unit and generating analysis time information; and calculating the amount of correction to the time based on the image pickup time of the image used for the analysis and the time indicated by the analysis time information, and correcting the time of the clock unit based on the amount of correction to the time.

According to a third embodiment of the present technology, there is provided a program for a computer to execute the functions of analyzing the time indicated by a code display on an image picked up by an image pickup unit and generating analysis time information; and calculating the amount of correction to the time based on the image pickup time of the image used for the analysis and the time indicated by the analysis time information, and correcting the time of the clock unit based on the amount of correction to the time.

According to a fourth embodiment of the present technology, there is provided an electronic apparatus comprising a clock unit for measuring time; a code information generation unit for generating code information based on the current time indicated by the clock unit; and a display unit for performing code display based on the code information.

In the electronic apparatus according to the present technology, code information is generated based on the current time, and based on this code information, a code display, such as a two-dimensional code or a bar code, is displayed. In addition, for the generation of the code information, a plurality of sets of code information having different update intervals are generated, and code displays indicating information corresponding to the respective update intervals are displayed. Furthermore, the electronic apparatus is provided with a receiver unit for receiving a radio signal indicating time information, and the clock unit performs the processing of adjusting the current time to the time indicated by the radio signal.

According to a fifth embodiment of the present technology, there is provided a time synchronization method comprising measuring time; generating code information indicating the measured current time; and performing code display based on the code information.

According to a sixth embodiment of the present technology, there is provided a program for a computer to execute the functions of generating code information indicating the current time measured by a clock unit; and displaying a code display on a display unit based on the code information.

In addition, with regard to a general-purpose computer capable of executing various kinds of programs/codes, the program according to the present technology is a program provided by a recording medium or a communication medium in a computer-readable form; for example, a recording medium, such as an optical disk, a magnetic disk or a semiconductor memory, or a communication medium, such as a network. By providing such program in a computer-readable form, processing according to the program is executed on the computer.

According to the present technology, the electronic apparatus of a synchronization source measures time and generates current time information, and then, based on the current time information, creates code information indicating the current time, and performs a code display based on the code information. In addition, the electronic apparatus of a synchronization destination calculates the amount of correction to the time based on the time acquired by analyzing the code display of an image picked up by an image pickup unit as well as the image pickup time of the image used for the analysis, and corrects the time of the clock unit based on the amount of correction to the time. For this reason, by using an electronic apparatus having a display function as the synchronization source and using an electronic apparatus having an image pickup function as the synchronization destination, it is possible to easily implement the time synchronization, without carrying out communications between the synchronization source and the synchronization destination. Moreover, even if the synchronization destination has a plurality of electronic apparatuses, all of them can be synchronized with the time of the electronic apparatus of the synchronization source at the same time.

### BRIEF DESCRIPTION OF THE DRAWINGS

FIG. 1 is a diagram showing the configuration of a time synchronization system;

FIG. 2 is a flowchart showing the operation of a synchronization source apparatus;

FIG. 3 is a diagram showing an example of a code display;

FIG. 4 is a flowchart showing the operation of a synchronization destination apparatus;

FIG. 5 is a diagram showing a timing chart of time synchronization processing;

FIG. 6 is a diagram showing another example of the code display; and

FIG. 7 is a diagram showing another configuration of the synchronization source device.

### DETAILED DESCRIPTION OF THE EMBODIMENT(S)

Hereinafter, preferred embodiments of the present disclosure will be described in detail with reference to the appended drawings. Note that, in this specification and the appended drawings, structural elements that have substantially the same function and structure are denoted with the same reference numerals, and repeated explanation of these structural elements is omitted.

The description of the embodiments according to the present disclosure will be made in the following order.

1. Configuration of the time synchronization system

2. Time synchronization processing

<1. Configuration of the Time Synchronization System>

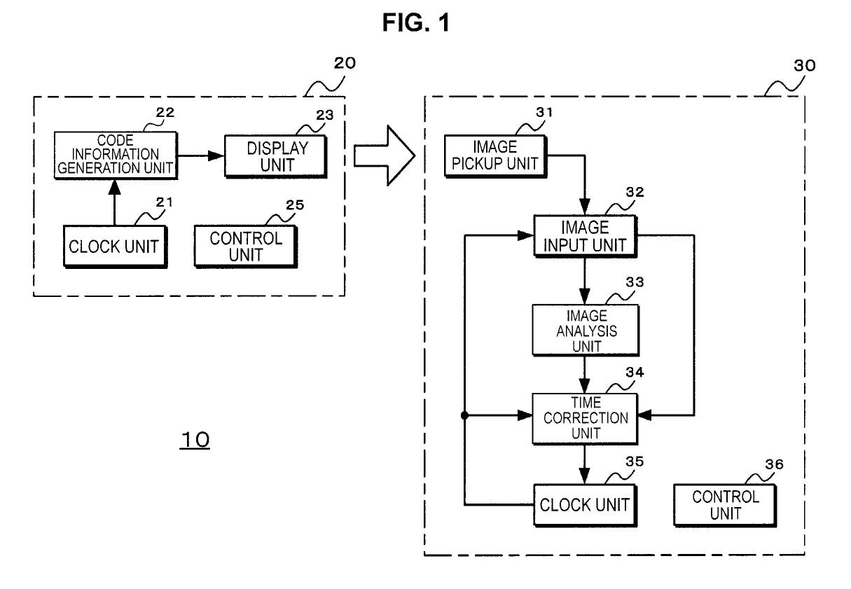

FIG. 1 shows the configuration of the time synchronization system. The time synchronization system 10 includes an electronic apparatus 20 having a clock function and a display function, and an electronic apparatus 30 having a clock function and an image pickup function. The electronic apparatus 20 performs operations as a time synchronization source, and displays code information indicating time. In addition, the electronic apparatus 30 performs operations as a synchronization destination, performs the image processing of a captured image of the code information displayed by the electronic apparatus 20 so as to acquire time information, and, based on the acquired time information, synchronizes its time with the time of the apparatus 20.

The electronic apparatus 20 performing as a time synchronization source (hereinafter, referred to as “synchronization source apparatus”) includes a clock unit 21, a code information generation unit 22, and a display unit 23, and a control unit 25.

The clock unit 21 measures time and generates time information indicating the current time, and then outputs the generated time information to the code information generation unit 22.

Based on the time information supplied by the clock unit 21 (hereinafter, referred to as “synchronization source time information”), the code information generation unit 22 generates code information and outputs the information to the display unit 23. The code information generated by the code information generation unit 22 may be a code, such as a bar code or a two-dimensional code, which indicates the synchronization source time information.

The display unit 23 includes a liquid crystal display or an organic light emitting diode display. The display unit 23 drives a display device based on the code information, and implements a code display, for example, in the form of a bar code or a two-dimensional code.

The control unit 25 controls operations of each part of the synchronization source apparatus 20. For instance, if the control unit 25 receives a command to start time synchronization processing, the control unit 25 controls the operations of the code information generation unit 22 and the display unit 23, and performs code display processing of synchronization source time information. Additionally, the control unit 25 completes the code display processing, e.g., when the control unit 25 receives a command to complete the time synchronization processing or when a certain period of time has passed since the start of the time synchronization processing.

The electronic apparatus 30 performing operations as a time synchronization destination (hereinafter, referred to as “synchronization destination apparatus”) includes an image pickup unit 31, an image input unit 32, an image analysis unit 33, a time correction unit 34, a clock unit 35, and a control unit 36.

The image pickup unit 31 includes a solid state image sensor, such as a CMOS (Complementary Metal-oxide-semiconductor) image sensor and a CCD (charge-coupled device) image sensor, and an optical system block for forming the image of an object on the imaging plane of the solid state image sensor. The image pickup unit 31 outputs the image signals of a captured image to the image input unit 32.

The image input unit 32 is supplied with time information from the clock unit 35, as will be described later. The image input unit 32 receives the image captured by the image pickup unit 31, and then outputs the received image to the image analysis unit 33. In addition, when receiving the image, the image input unit 32 outputs the time information to the time correction unit 34 as image pickup time information.

The image analysis unit 33 carries out an analysis of the received image. For the analysis of the image, the image analysis unit 33 assesses the code display, and analyzes the time indicated by the code display, and generates analysis time information indicating the analysis result. The image analysis unit 33 outputs the generated analysis time information to the clock correction unit 34.

The clock correction unit 34 calculates the amount of time correction, based on the pickup time information supplied by the image input unit 32 and the analysis time information that the image analysis unit 33 has generated by analyzing the image received at the time which the pickup time information indicates. In addition, the time correction unit 34 corrects time information supplied by the clock unit 35 based on the amount of time correction, and generates synchronization time information indicating the time synchronized with the synchronization source apparatus 20, and outputs it to the clock unit 35.

The clock unit 35 measures time, and generates time information indicating the current time, and outputs the time information to the image input unit 32 and the time correction unit 34. In addition, when the time synchronization information is supplied by the time correction unit 34, the clock unit 35 corrects the current time to the time indicated by the synchronization time information, and measures time.

The control unit 36 controls the operations of each part of the synchronization destination apparatus 30. For instance, when the control unit 36 receives a command to start the time synchronization processing, the control unit 36 performs controls the operations of each part to synchronize the time of the clock unit 35 with the time of the synchronization source apparatus 20 based on the code display of the synchronization source apparatus 20.

<2. Time Synchronization Processing>

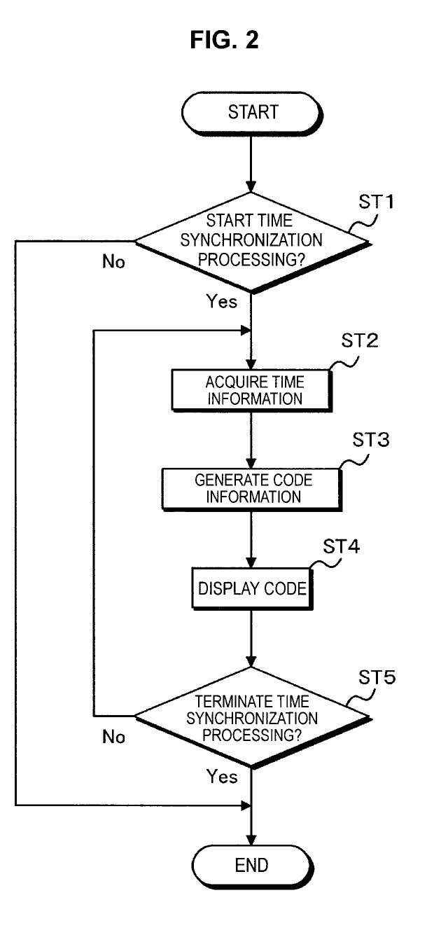

Next, the operations of the time synchronization system will be described. FIG. 2 is a flowchart showing the operations of the synchronization source apparatus 20. At step ST1, the synchronization source apparatus 20 determines whether the time synchronization processing should be executed. If the control unit 25 of the synchronization source apparatus 20 receives a command to start the time synchronization processing, the control unit 25 controls each part to perform the processing from step ST2. In the absence of the command to start the time synchronization processing, the control unit 25 is configured such that the processing from step ST2 is not performed.

At step ST2, the synchronization source apparatus 20 performs the acquisition of time information. The code information generation unit 22 acquires time information generated by the clock unit 21 (synchronization source time information), and proceeds to step ST3.

The synchronization source apparatus 20 performs the generation of code information at step ST3. The code information generation unit 22 generates a code indicating the acquired synchronization source time information, for example, a bar code and a two-dimensional code, and proceeds to step ST4.

At step ST4, the synchronization source apparatus 20 performs a code display. The display unit 23 drives a display device to perform the code display based on the code information generated at ST3, and proceeds to ST5.

At step ST5, the synchronization source apparatus 20 determines whether to end the time synchronization processing. If the control unit 25 receives a command to end the time synchronization processing or a predetermined time has elapsed since the start of the time synchronization processing, the control unit 25 determines it as the end of the time synchronization processing, and terminates the processing. In addition, if it is not determined as the end of the time synchronization processing, the synchronization source unit 20 returns to step ST2, and acquires new time information and performs a code display.

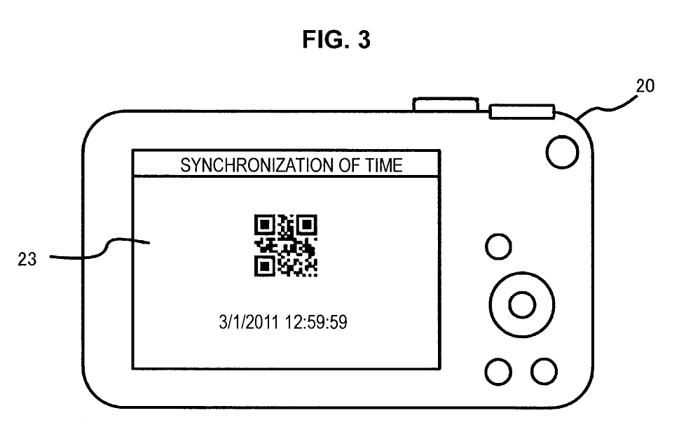

FIG. 3 shows an example of a code display in which the synchronization source unit 20 is an image pickup apparatus. When executing the time synchronization processing, the synchronization source unit 20 displays a two-dimensional code indicating the current time on the display unit 23 which, for example, performs the display of a captured image or a menu, etc. Moreover, the code display by the display unit 23 is updated at certain intervals of time interval, for example, every second.

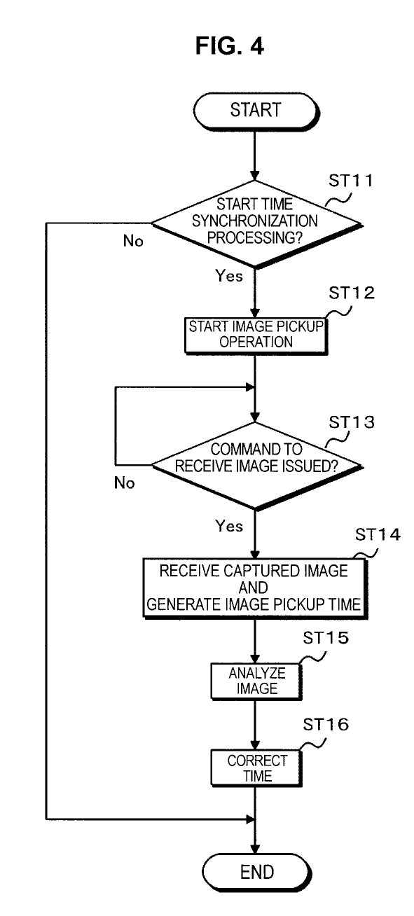

FIG. 4 is a flowchart showing the operations of the synchronization destination apparatus 30. At step ST11, the synchronization destination apparatus 30 determines whether to start time synchronization processing. If a command to start the time synchronization processing is received, the control unit 36 of the synchronization destination apparatus 30 controls each part to perform the processing from step ST12. In addition, in the absence of the command to start the time synchronization, the control unit 36 is configured such that the processing from step ST12 is not performed.

At step 12, the synchronization destination apparatus 30 starts the image pickup operation. The image pickup unit 31 starts the generation of the image signals of the captured image, and proceeds to step ST13.

At step ST13, the synchronization destination apparatus 30 determines whether there is a command to receive the image. If it is determined that there is a command to receive the image, the synchronization destination apparatus 30 proceeds to step ST 14, and if it is determined that there is not the command to receive the image, the synchronization destination apparatus 30 returns to step ST 13. The command to receive the image, for example, can be given by the user, who confirms that the imaging of the code display has been made, and gives the command to receive the image. In addition, the command to receive the image may be automatically given when it is confirmed by an image analysis that the imaging of the code display has been made.

At step 14, the synchronization destination apparatus 30 performs the reception of the captured image and the generation of imaging time information. The image input unit 32 performs the reception of the captured image including a code display. In addition, as the time information when the reception of the image is made is regarded as the image pickup time information, the image input unit 32 proceeds to step ST15.

At step ST 15, the synchronization destination apparatus 30 performs an image analysis. The image analysis unit 33 performs the analysis of the time indicated by the code display of the captured image received at step ST 14, and generates analysis time information indicating the analysis result, and then proceeds to step ST 16.

At step ST 16, the synchronization destination apparatus 30 executes a time correction. The time correction unit 34 calculates the amount of correction to the time based on the image pickup time information generated at step ST 14 and the analysis time information generated at ST 15. In addition, the time correction unit 34 makes a correction to the time information supplied by the clock unit 35 based on the calculated amount of correction, and generates synchronization time information indicating the time synchronized with the synchronization source apparatus 20. Moreover, the time correction unit 34 outputs the generated synchronization time information to the clock unit 35, and corrects the current time of the clock unit 35 to the time indicated by the synchronization time information, and then ends the time synchronization processing.

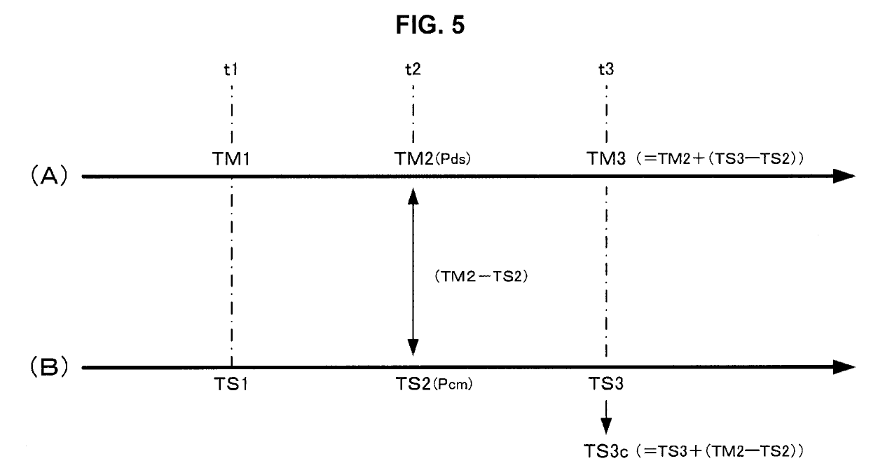

FIG. 5 shows a timing chart of the time synchronization processing. Further, FIG. 5(A) shows the time TM of the clock unit 21 in the synchronization source unit 20, and FIG. 5(B) shows the time TS of the clock unit 35 in the synchronization destination apparatus 30.

If the time synchronization processing starts at time t1 (=TM1), the synchronization source apparatus 20 performs a code display of the synchronization source time information indicating the time of the clock unit 21.

If the captured image of the code display is received by the synchronization destination apparatus 30 at time t2 (=TM2, TS2), the image pickup time Pcm becomes ‘TS2.’ Then, after completing an image analysis, a correction of time is made at time t3 (=TM3, TS3) based on the synchronization source time Pds (=TM2) acquired by the image analysis. In this case, since the time between time t2 and time t3 is ‘TS3−TS2’, the time TM3 at time t3, as shown in equation (1), is obtained by adding the time ‘TS3−TS2’ to the time ‘TM2’ indicated by the synchronization source time information.

TM3=TM2+(TS3−TS2) (1)

On the other hand, in the synchronization destination apparatus 30, from the synchronization source time Pds and the image pickup time Pcm at time t2, it becomes clear that time difference between the synchronization source apparatus 20 and the synchronization destination apparatus 30 is ‘TM2−TS2’. Therefore, as shown in equation (2), the time difference is added to the time TS3 of the synchronization destination apparatus 30 at time t3, and the time TS3 of the clock unit 35 is corrected to TS3c.

TS3c=TS3+(TM2−TS2) (2)

Here, because the time TM3 and the time TM3 are the same time, the time of the clock unit 35 of the synchronization destination apparatus 30 can be synchronized with the time of the clock unit 21 of the synchronization source apparatus 20.

Meanwhile, if the update interval of the code display is set to be short, the time of the synchronization destination apparatus 30 can be synchronized with the time of the synchronization source apparatus 20 with high precision. However, if the update interval of the code display is short, it is probable that the replacement of the code display takes place during the period of the charge accumulation of an image received by the image input unit 32, and thus an accurate time analysis cannot be made. Therefore, the synchronization source apparatus 20 generates a plurality of sets of code information having different update intervals, and provides a plurality of code displays on the screen of the display unit 23.

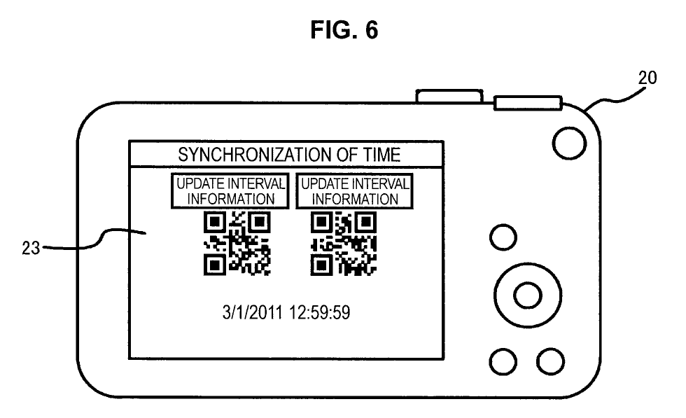

FIG. 6 illustrates an example in which two kinds of code information having different update intervals generated in the synchronization source apparatus 20 are provided on the screen of the display unit 23. If a plurality of codes having different update intervals are displayed on the screen of the display unit 23, as shown in FIG. 6, the synchronization destination apparatus 30 can generate analysis time information more reliably compared to the case where there is only one code display. Therefore, the time of the clock unit 35 can be more reliably synchronized with the time of the synchronization destination apparatus 30. Moreover, the plurality of codes having different update intervals may be displayed on the screen of the display unit 23 along with update interval information so that the update intervals are identifiable. In this case, if a plurality of kinds of time information having different update intervals are acquired from an image analysis, the synchronization destination apparatus 30 uses the time information acquired from the analysis of a code display having the shortest update interval as analysis time information. In this way, it can be ensured that the time of the synchronization destination apparatus 30 is reliably synchronized with the time of the synchronization source apparatus 20. In addition, the update interval information may use, for example, codes, numbers, and symbols, etc., from which the update intervals are identifiable. Furthermore, the arrangement of code displays may be determined in advance in accordance with the update intervals. For instance, the arrangement of the code displays may be predetermined in the synchronization source apparatus 20 and the synchronization destination apparatus 30 such that the update interval of a code display on the right side is shorter than that of a code display on the left side. In this way, if a plurality of kinds of time information are acquired by an image analysis, the synchronization destination apparatus 30 can use time information having the shortest update interval as analysis time information by selecting the analysis result of the code display arranged on the right most.

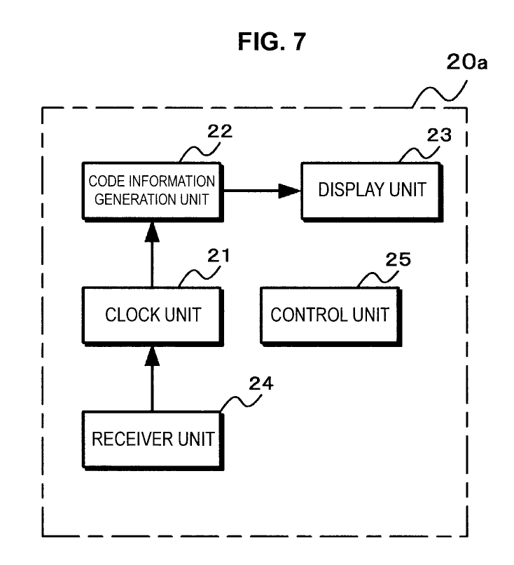

In addition, as shown in FIG. 7, the time of each electronic apparatus can be correctly set by providing a receiver unit 24 for receiving radio signals with time information superimposed thereon in the synchronization source apparatus 20a, without providing a receiver unit in the synchronization destination unit. In other words, the receiver unit 24 receives, for example, radio signals from navigation satellites, radio signals from base stations or communication terminals of a radio communication network system, and radio signals indicating time information transmitted from a time synchronization protocol server via a communication terminal. The receiver unit 24 corrects the time of the clock unit 21 to the time indicated by the received radio signals. In this way, if the time of the synchronization source unit 20a is set at the correct time, by carrying out the processing described above, the time of each synchronization destination apparatus 30 can be adjusted to the correct time with ease.

The processing described in the specification may be performed by hardware, software, or a configuration of the combination thereof. In the case where the processing is executed by software, a program with a recorded processing sequence is installed and run in the memory of a computer built into dedicated hardware. In addition, it is also possible to install and run the program on a general-purpose computer that is capable of executing various kinds of processing.

For instance, the program can be recorded in advance in a ROM (Read Only Memory) or a hard disk drive as a recording medium. Alternatively, the program can be stored (recorded) either temporarily or permanently in a removable recording medium, such as a flexible disk, a CD-ROM (Compact Disc Read Only Memory), a MO (Magneto-optical) disk, a DVD (Digital Versatile Disc), a magnetic disk, and a semiconductor memory card. Such removable recording medium can be provided as the so-called package software.

Not only can the program be installed on a computer from a removable recording medium, the program can also be transmitted to the computer via a network, either wireless or wired, such as the Internet or a LAN (Local Area Network), from a download site. The computer can receive the thus transmitted program and install on a recording medium, such as a built-in hard disk drive.

In addition, it is noted that this technology should not be construed as limited to the embodiments described above. The embodiments of this technology have been disclosed in the form of examples, and it is apparent that those skilled in the art would be able to make modifications and substitutions without departing from the gist of this technology. In other words, in order to determine the gist of this technology, the appended claims should be taking into consideration.

Additionally, the present technology may also be configured as below.

(1) An electronic apparatus comprising:

an image pickup unit;

a clock unit for measuring time;

an image analysis unit for analyzing time indicated by a code display on an image captured by the image pickup unit and generating analysis time information; and

a time correction unit for calculating the amount of correction to the time based on the image pickup time of the image used for the analysis and the time indicated by the analysis time information, and correcting the time of the clock unit based on the amount of correction to the time.

(2) The apparatus according to (1), wherein the time correction unit calculates the difference between the image pickup time and the time indicated by the analysis time information as said amount of correction to the time.
(3) The apparatus according to (1) or (2), wherein if a plurality of times having different update intervals are acquired from the analysis of time, the image analysis unit generates analysis time information indicating the time having a shorter update interval.
(4) The apparatus according to (3), wherein the image analysis unit generates the analysis time information indicating the time having the shorter update interval, based on information indicating an update interval displayed corresponding to the code display.
(5) The apparatus according to (3), further comprising a display unit for determining the order of the update intervals based on the order in which the code displays are arranged, and, based on the determination result, generating the analysis time information indicating the shorter update interval.
(6) An electronic apparatus comprising:

a clock unit for measuring time;

a code information generation unit for generating code information based on the current time indicated by the clock unit; and

a display unit for performing code display based on the code information.

(7) The apparatus according to claim (6), wherein the code information generation unit generates a plurality of kinds of code information having different update intervals.
(8) The apparatus according to (7), wherein the display unit displays the code displays with corresponding information indicating the respective update intervals.
(9) The apparatus according to (7), wherein the display unit displays the code displays according to the order of the time interval of the update intervals.
(10) The apparatus according to any one of (6) to (9), wherein the code information generation unit generates a two-dimensional code or a bar code as the code information.
(11) The apparatus according to any one of (6) to (10), further comprising a receiver unit for receiving radio signals indicating time information, wherein the clock unit adjusts the current time to the time indicated by the radio signals.

In the electronic apparatus, and time synchronization method and program according to the present technology, the time synchronization source measures time and generates current time information, and, based on the current time information, the time synchronization source generates code information indicating the current time, and generates a code display based on the code information. In addition, the time synchronization destination calculates the amount of correction based on the time acquired by analyzing the code display of an image captured by the image pickup unit as well as the image pickup time of the image used for the analysis, and then corrects the time of the clock unit based on the amount of correction. For this reason, by using an electronic apparatus having a display function as the synchronization source, and using an electronic apparatus having an image pickup function as the synchronization destination, it is possible to easily achieve time synchronization, without performing communications between the synchronization source and the synchronization destination. Moreover, even if the synchronization destination has a plurality of electronic apparatuses, all of them can be synchronized with the electronic apparatus of the synchronization source at the same time. Therefore, the present technology is suitable for synchronizing the time of an electronic apparatus, such as an image pickup apparatus.

It should be understood by those skilled in the art that various modifications, combinations, sub-combinations and alterations may occur depending on design requirements and other factors insofar as they are within the scope of the appended claims or the equivalents thereof.

The present disclosure contains subject matter related to that disclosed in Japanese Priority Patent Application JP 2011-176235 filed in the Japan Patent Office on Aug. 11, 2011, the entire content of which is hereby incorporated by reference.

What is claimed is:

1. An electronic apparatus comprising:
an image pickup unit;
a clock unit for measuring time;
an image analysis unit for analyzing time indicated by a code display on an image captured by the image pickup unit and generating analysis time information; and
a time correction unit for calculating the amount of correction to the time based on the image pickup time of the image used for the analysis and the time indicated by the analysis time information, and correcting the time of the clock unit based on the amount of correction to the time.

2. The apparatus according to claim 1, wherein the time correction unit calculates the difference between the image pickup time and the time indicated by the analysis time information as said amount of correction to the time.

3. The apparatus according to claim 1, wherein if a plurality of times having different update intervals are acquired from the analysis of time, the image analysis unit generates analysis time information indicating the time having a shorter update interval.

4. The apparatus according to claim 3, wherein the image analysis unit generates the analysis time information indicating the time having the shorter update interval, based on information indicating an update interval displayed corresponding to the code display.

5. The apparatus according to claim 3, further comprising a display unit for determining the order of the update intervals based on the order in which the code displays are arranged, and, based on the determination result, generating the analysis time information indicating the shorter update interval.

6. A time synchronization method comprising:
measuring time with a clock unit;
analyzing time indicated by a code display on an image captured by an image pickup unit and generating analysis time information; and
calculating the amount of correction to the time based on the image pickup time of the image used for the analysis and the time indicated by the analysis time information, and correcting the time of a clock unit based on the amount of correction to the time.

7. A program for a computer to execute the functions of:
analyzing time indicated by a code display on an image captured by an image pickup unit and generating analysis time information; and
calculating the amount of correction to the time based on the image pickup time of the image used for the analysis and the time indicated by the analysis time information, and correcting the time of a clock unit based on the amount of correction to the time.

8. An electronic apparatus comprising:
a clock unit for measuring time;
a code information generation unit for generating code information based on the current time indicated by the clock unit; and
a display unit for performing code display based on the code information.

9. The apparatus according to claim 8, wherein the code information generation unit generates a plurality of kinds of code information having different update intervals.

10. The apparatus according to claim 9, wherein the display unit displays the code displays with corresponding information indicating the respective update intervals.

11. The apparatus according to claim 9, wherein the display unit displays the code displays according to the order of the time interval of the update intervals.

12. The apparatus according to clam 8, wherein the code information generation unit generates a two-dimensional code or a bar code as the code information.

13. The apparatus according to claim 8, further comprising a receiver unit for receiving radio signals indicating time information, wherein the clock unit adjusts the current time to the time indicated by the radio signals.

14. A method of time synchronization, comprising:
measuring time;
generating code information indicating the current time; and
performing code display based on the code information.

15. A program for a computer to execute the functions of:
generating code information indicating the current time measured by a clock unit; and
performing code display on a display unit based on the code information.
